(19) United States
(12) Patent Application Publication
(10) Pub. No.: US 2016/0275248 A1
(43) Pub. Date: Sep. 22, 2016

(54) HEALTHCARE DEVICE, HEALTHCARE GATEWAY, AND VERIFICATION METHOD FOR HEALTHCARE DEVICE

(71) Applicant: ELECTRONICS AND TELECOMMUNICATIONS RESEARCH INSTITUTE, Daejeon (KR)

(72) Inventors: Sin Hyo KIM, Daejeon (KR); Hyeok Chan KWON, Daejeon (KR); Jong Sik MOON, Daejeon (KR); Gaeil AN, Daejeon (KR); SOKJOON LEE, Daejeon (KR); DO YOUNG CHUNG, Daejeon (KR); Byung Ho CHUNG, Daejeon (KR)

(21) Appl. No.: 15/072,196

(22) Filed: Mar. 16, 2016

(30) Foreign Application Priority Data
Mar. 20, 2015 (KR) 10-2015-0039019

(51) Int. Cl. G06F 19/00

(52) U.S. Cl. CPC G06F 19/322; G06F 19/3406

(57) ABSTRACT

Provided is a healthcare device including a sensor unit configured to collect patient's biometric information or perform medical treatment on the patient; a communication unit configured to communicate with a healthcare gateway; a control unit configured to receive a control command from the healthcare gateway through the communication unit and control the sensor unit according to the received control command; and a device verification unit configured to receive a verification request from the healthcare gateway, verify an error of the control unit or the sensor unit in response to the received verification request, and transmit results of the verification to the healthcare gateway.

### CROSS-REFERENCE TO RELATED APPLICATIONS

This U.S. non-provisional patent application claims priority under 35 U.S.C. §119 of Korean Patent Application No. 10-2015-0039019, filed on Mar. 20, 2015, the entire contents of which are hereby incorporated by reference.

### BACKGROUND

The present disclosure herein relates to a healthcare service system, and more particularly, to a healthcare device, a healthcare gateway, and a verification method for a healthcare device.

Medical devices and medical sensors with which electronics are combined are being used in various medical fields. In particular, with the development in electronic technology, the performance and function of the medical devices and medical sensors are being enhanced. These medical devices and medical sensors collect personal biometric information (e.g., blood pressure, pulsation, weight, blood sugar, etc.) and provide it to external servers or perform medical treatment according to the control of a supervisor. In recent, with the development in communication technology, the above-described medical devices and medical sensors are connected to wired or wireless communication networks to collect personal biometric information and perform medical treatment remotely. Based on these medical devices, medical sensors, and network technologies, various healthcare services may be provided.

The medical devices used in the healthcare service are connected to networks to send and receive biometric information or commands. That is, the medical devices for the healthcare service are exposed to hacking. Since the medical devices perform operations associated with human being's health and life, it is possible to have a critical effect on the human being's health and life when the medical devices malfunction due to the above-described attack or errors. In recent, the healthcare service gets the spotlight, thus various special organizations such as Institute of Electrical and Electronics Engineers (IEEE) has presented network transmission protocols and standards for the healthcare service but these standards are simply focused on the communication protocols between medical devices for the healthcare service. That is, there is a limitation in that the malfunction of the medical devices due to the safety or internal errors of the medical devices resulting from attacks from the outside is not considered. Thus, there is a need for a method and device that may ensure the safety of the medical devices in order to provide a secure healthcare service.

### SUMMARY

The present disclosure provides a healthcare device, a healthcare gateway, and a verification method for a healthcare device that prevent the malfunction of healthcare devices due to external attacks or internal errors to have enhanced reliability.

Embodiments of the inventive concept provide healthcare devices including a sensor unit configured to collect patient's biometric information or perform medical treatment on the patient; a communication unit configured to communicate with a healthcare gateway; a control unit configured to receive a control command from the healthcare gateway through the communication unit and control the sensor unit according to the received control command; and a device verification unit configured to receive a verification request from the healthcare gateway, verify an error of the control unit or the sensor unit in response to the received verification request, and transmit results of the verification to the healthcare gateway.

In example embodiments, the healthcare device may be attached to a body of the patient.

In example embodiments, the control unit may be configured to transmit the collected patient's biometric information to the healthcare gateway through the communication unit.

In example embodiments, the control unit may be configured to receive a security measure command from the healthcare gateway when the verification result is fail.

In example embodiments, the control unit may be configured to perform a security measure according to the received security measure command.

In example embodiments, the security measure may include at least one of rebooting, program update, and hardware reset operations.

In example embodiments of the inventive concept, healthcare gateways include a communication unit configured to communicate with a healthcare device; a monitoring unit configured to receive a verification result from the healthcare device through the communication unit and manage the received verification result; and a control unit configured to transmit any one of a control command or a security measure command to the healthcare device according to the verification result, wherein the control command indicates a command corresponding to a normal operation of the healthcare device, and the security measure command indicates a command corresponding to a security measure of the healthcare device.

In example embodiments, the control unit may be configured to transmit a security measure command to the healthcare device when the verification result is fail, and transmit a control command to the healthcare device when the verification result is safe.

In example embodiments, the control unit may be configured to further transmit, to the healthcare device, information required for the security measure of the healthcare device when the verification result is fail.

In example embodiments, the healthcare gateways may further include a request management unit configured to receive the patient's biometric information from the healthcare device and manage the received patient's biometric information.

In example embodiments, the communication unit may be configured to communicate with an external server. The request management unit is configured to transmit, to the external server, the managed patient's biometric information according to a request from the external server.

In example embodiments of the inventive concept, verification methods for a healthcare device include transmitting a verification request from a healthcare gateway; performing a verification operation in response to the verification request to transmit the verification result to the healthcare gateway; receiving any one of a control command and a security measure command from the healthcare gateway; and performing any one of a normal operation and a security measure in response to any one of the control command and the security measure command, wherein the normal operation indicates an operation of transmitting the collected patient's biometric information to the healthcare gateway or performing medical treatment on the patient by the healthcare device, and the security measure indicates an operation of performing rebooting or a software update by the healthcare device.

In example embodiments, the performing of the verification operation in response to the verification request to transmit the verification result to the healthcare gateway may include performing verification on software used in the healthcare device based on a predefined key value.

In example embodiments, the performing of any one of the normal operation and the security measure in response to any one of the control command and the security measure command may include receiving the security measure command from the healthcare gateway when the verification result is fail, and receiving the control command from the healthcare gateway when the verification result is safe.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a diagram showing a healthcare service system according to an embodiment of the inventive concept;

FIG. 2 is a block diagram showing a healthcare device and gateway of FIG. 1 in detail;

FIG. 3 is a flowchart of an operation of the healthcare device of FIG. 2;

FIG. 4 is a flowchart of another operation of the healthcare device of FIG. 2;

FIG. 5 is a flowchart of an operation of the healthcare gateway of FIG. 2;

FIG. 6 is a diagram showing an operation of a healthcare service system of FIG. 2; and

FIG. 7 and FIG. 8 are diagrams showing another operation of the healthcare service system of FIG. 2.

### DETAILED DESCRIPTION

In the following, embodiments of the inventive concept are described with reference to the accompanying drawings in order to describe the inventive concept in detail so that a person skilled in the art to which the inventive concept pertains may easily practice the technical spirit of the inventive concept.

In this specification, components which are described with reference to terms “unit”, “module”, “layer”, and the like may be implemented with software, hardware, or a combination thereof. In exemplary embodiments, software may be firmware, embedded code, and application software. For example, hardware may include a circuit, a processor, a computer, an integrated circuit, integrated circuit cores, a pressure sensor, an inertial sensor, microelectromechanical system (MEMS), a passive element, or a combination thereof.

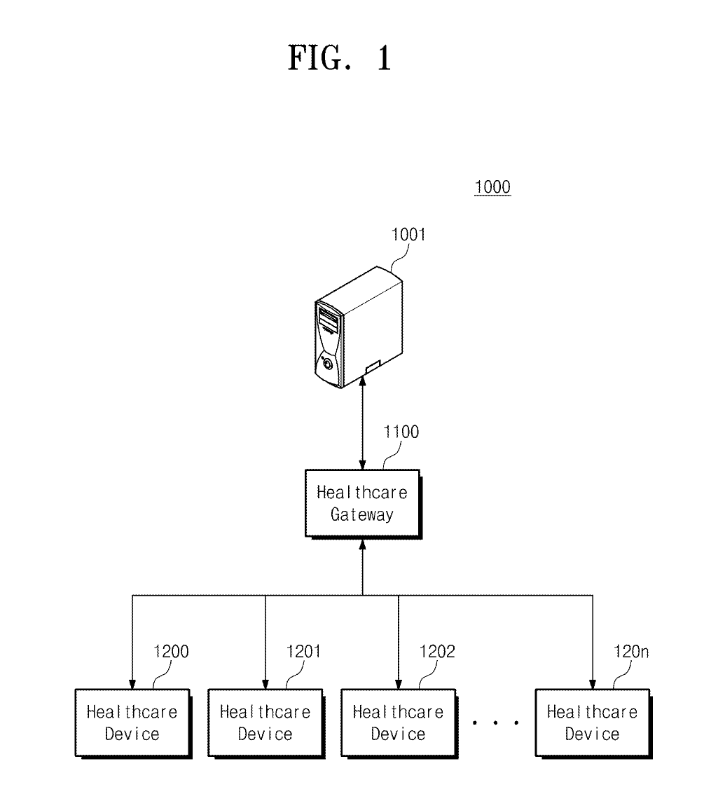

FIG. 1 is a diagram showing a healthcare service system according to an example embodiment of the inventive concept. Referring to FIG. 1, a healthcare service system 1000 includes a server 1100, a healthcare gateway 1200, and healthcare devices 1310 to 1360. As an example, the healthcare service system 100 may acquire patient information and perform remote treatment and remote prescription through a communication network between a patient and a healthcare provider. For example, each of the healthcare devices 1200 to 120n may be carried by each of patients or attached to the bodies of the patients, and sense biometric information on each of the patients according to the control of the server 1001 to transmit the information to the server 1001 through the healthcare gateway 1100 or perform medical treatment on the patients according to the control of the server 1001.

The server 1001 may be connected to the gateway 1100 through a public communication network and collect patient's biometric information from the gateway 1100. The server 1001 may include personal information on each of patients. The server 1001 may control the healthcare devices 1200 to 120n based on the collected biometric information and personal information on the patients. For example, the server 1001 may control the healthcare devices 1200 to 120n so that the healthcare devices 1200 to 120n perform medical treatment operations based on the collected biometric information and personal information on the patients. As an example, the server 1001 may be controlled by a medical professional or medial organization or provide the collected information to the outside.

The healthcare gateway 1100 (hereinafter, referred to as ‘gateway’) may provide a communication interface between the server 1001 and the healthcare devices 1200 to 120n. For example, the gateway 1100 may communication with the server 1001 through a public communication network. The public communication network is a communication network provided between a plurality of users and includes a telephone network, digital data exchange (DDX) network, etc. The gateway 1100 may communication with the plurality of healthcare devices 1200 to 120n through a wired or wireless communication network. The wired or wireless communication network may include at least one of various communication methods, such as Zigbee, Bluetooth, Local Area Network (LAN), Wide Area Network (WAN), Universal Serial Bus (USB), IEEE 11073, WI-FI, Wibro, HSDPA, WiMAX, UWB, IrDA, SWAP, near field communication, etc.

The gateway 1100 may mutually interconvert data according to a communication method with the server 1001 and data according to a communication method with the plurality of healthcare devices 1200 to 120n. More specifically, the gateway 1100 may receive a control command from the server 1001, and convert the received control command into a control command according to the communication method with the plurality of healthcare devices 1200 to 120n to transmit the control command obtained through conversion to the plurality of healthcare devices 1200 to 120n. Likewise, the gateway 1100 may receive data from the plurality of healthcare devices 1200 to 120n, convert the received data into the data according to the communication method with the server 1001, and transmit the converted data to the server 1001.

Each of the healthcare devices 1200 to 120n may be carried by a patient or attached to the body of the patient. The healthcare devices 1200 to 120n may receive a control command from the gateway 1200 to 120n, and operate in response to the received control command. For example, the healthcare device 1200 may receive a biometric information collection command from the gateway 1100. In response to the received command, the healthcare devices 1200 may collect information such as patient's biometric information (e.g., blood pressure, pulse, blood sugar, weight, height, body temperature, etc.) and transmit the collected information to the gateway 1100. However, the healthcare devices 1200 to 120n according to the technical sprit of the inventive concept is not limited thereto and may include various medical treatment devices, such as a biometric information sensor, hearing aid, respirator, diabetes management device, blood pressure management device, medicine treatment device, injection device, etc.

As example embodiments, the healthcare devices 1200 to 120n may operate by performing a predefined program code (or algorithm) under the control of the gateway 1100. When the program code used in the healthcare devices 1200 to 120n is damaged due to an external factor (e.g., hacking) or internal factor (e.g., program error), the healthcare devices 1200 to 120n malfunction. Since the healthcare devices 1200 to 120n collects patient's biometric information or performs medical treatment on the patient, the malfunction of the healthcare devices 1200 to 120n may have a great effect on the patient's health or life.

The gateway 1100 according to an example embodiment of the inventive concept may manage the safety of the healthcare devices 1200 to 120n. For example, the gateway 1100 may transmit a safety verification request to the healthcare devices 1200 to 120n. The healthcare devices 1200 to 120n may perform self-verification for program code in response to the received safety verification request. The healthcare devices 1200 to 120n may transmit a verification result to the gateway 1100. The gateway 110 may transmit a security measure command to the healthcare devices 1200 to 120n so that the healthcare devices 1200 to 120n performs a security operation (e.g., rebooting, a program update, etc.) based on the received verification result.

According to an example embodiment of the inventive concept as described above, the healthcare devices 1200 to 120n perform a self-verification operation under the control of the gateway 1100. The gateway 110 may control the healthcare devices 1200 to 120n according to the verification result to prevent the malfunction of the healthcare devices 1200 to 120n due to an external or internal factor. Thus, a healthcare device, a healthcare gateway, and a verification method for a healthcare device that have enhanced reliability are provided.

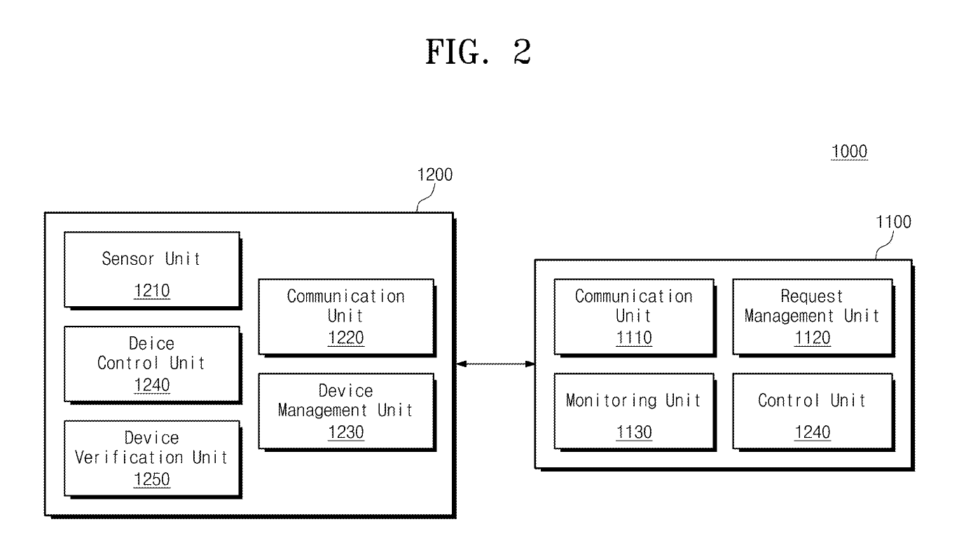

FIG. 2 is a block diagram showing a healthcare device and gateway of FIG. 1 in detail. For the simplicity of description, a gateway 1100 and a healthcare device 1200 are descried with reference to FIG. 2. However, the scope of the inventive concept is not limited thereto and other healthcare devices 1201 to 120n may also have similar structures.

Referring to FIG. 2, the gateway 1100 may include a communication unit 1110, a request management unit 1120, a monitoring unit 1130, and a control unit 1140. The communication unit 1110 may support communication with the healthcare device 1200. As an example, the communication unit 1110 may support a wired or wireless communication interface. As an example, the communication unit 1110 may support communication with the server 1001.

The request management unit 1120 may manage a request received from the server 1001. For example, the request management unit 1120 may manage and store information received from the healthcare device 1200. As an example, the request management unit 1120 may transmit information collected from the healthcare device 1200 to the server 1001 through the communication unit 1110 according to the request from the server 1001.

The monitoring unit 1130 may support the safety of the healthcare device 1200. For example, the monitoring unit 1130 may transmit, to the healthcare device 1200, a verification request for verifying the safety of the healthcare device 1200. The monitoring unit 1130 may receive a verification result from the healthcare device 1200 and manage the received verification result.

The control unit 1140 may control the overall operations of the gateway 1100. The control unit 1140 may control the healthcare device 1200 based on the verification result managed by the monitoring unit 1130. For example, when the verification result of the healthcare device 1200 is fail, the control unit 1140 may transmit a security measure command to the healthcare device 1200 so that the healthcare device 1200 performs a security operation. When the verification result of the healthcare device 1200 is safe, the control unit 1140 may transmit a control command to the healthcare device 1200. The healthcare device 1200 may perform a corresponding operation in response to the control command. As an example, the control command may be a command for a request from the server 1001 managed by the request management unit 1120. Alternatively, the control command may be a command for biometric information collection that is performed regularly or irregularly.

The healthcare device 1200 may include a sensor unit 1210, a communication unit 1220, a device management unit 1230, a device control unit 1240, and a device verification unit 1250.

The sensor unit 1210 may collect patient's biometric information or perform medical treatment on the patient. As an example, the sensor unit 1210 may include sensors for collecting patient's biometric information, such as a blood pressure sensor, a pulse sensor, a temperature sensor, etc. Alternatively, the sensor unit 1210 may further include devices for performing medical treatment on the patient, such as an injection device, a medicine treatment device, etc.

The communication unit 1220 supports communication with the gateway 1100. As an example, the communication unit 1220 may support a wired or wireless communication interface.

The device management unit 1230 may store and manage patient's biometric information that is collected by the sensor unit 1210.

The device control unit 1240 may control the overall operations of the healthcare device 1200. The device control unit 1240 may control the sensor unit 1210 according to the control of the gateway 1100. For example, the device control unit 1240 may control the sensor unit 1210 so that the sensor unit 1210 collects the patient's biometric information or performs medical treatment on the patient according to the control of the gateway 1100. Alternatively, the device control unit 1240 may control the sensor unit 1210 so that the sensor unit 1210 collects the patient's biometric information regularly or irregularly. The patient's biometric information that is collected by the sensor unit 1210 may be managed by the device management unit 1230.

As an example, the device management unit 1240 may receive a security measure command from the gateway 1100, and perform a security measure (e.g., rebooting, a software update, etc.) in response to the received security measure command.

The device verification unit 1250 may perform a verification operation in response to a verification request from the gateway 1100. For example, each of the components of the healthcare device 1200 may operate according to a predefined program code (or algorithm). More specifically, the device control unit 1240 may operate according to a predefined program code. The device verification unit 1250 may verify the integrity of the program code of the device control unit 1240. As an example, the device verification unit 1250 may include a key value for a predefined program code. The device verification unit 1250 may verify the integrity of the program code of the device control unit 1240 based on the key value. Alternatively, the device verification unit 1250 may verify the sensor unit 1210 based on the key value.

In the following, for the simplicity of description, it is assumed that the verification operation is a verification operation for the program code of the healthcare device 1200. However, the scope of the inventive concept is not limited thereto and the verification operation may include verification operations for the program code, other software layers, and other hardware devices.

As example embodiments, the device verification unit 1250 may not vary by an external attack or internal error. That is, the device verification unit 1250 may be implemented in software and stored in a reliable storage medium (e.g., shielded memory, ROM, etc.).

As example embodiments, the verification result of the device verification unit 1250 may be managed by the device management unit 1230. Also, the device control unit 1240 may operate according to the verification result of the device verification unit 1250. For example, when the verification result of the device verification unit 1250 indicates ‘failure’, the reliability of the healthcare device 1200 may not be guaranteed. In this case, the device control unit 1240 may control the sensor unit 1210 so that the sensor unit 1210 does not operate based on the device management unit 1230. When the verification unit of the device verification unit 1250 is safe, the control unit 1230 may perform general operations.

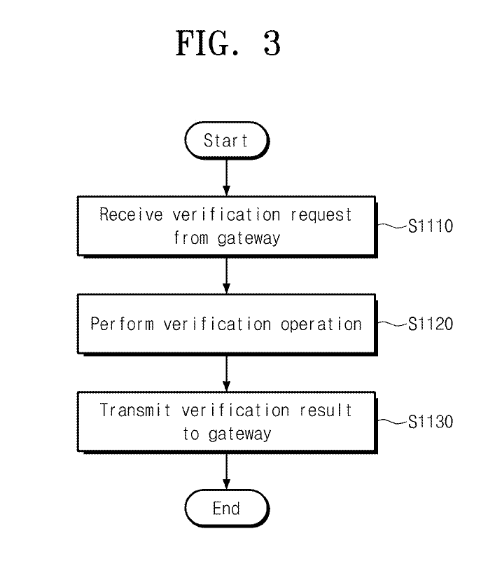

FIG. 3 is a flowchart of an operation of a healthcare device of FIG. 2. Referring to FIGS. 2 and 3, in step S1110, the healthcare device 1200 may receive a verification request from the gateway 1100.

In step S1120, the healthcare device 1200 may perform a verification operation. For example, the device verification unit 1250 may verify the program code of the healthcare device 1200 in response to a verification request.

In step S1130, the healthcare device 1200 may transmit a verification result to the gateway 1100. For example, the healthcare device 1200 may transmit, to the gateway 1100, information on failure or safe according to the verification result of the device verification unit 1250.

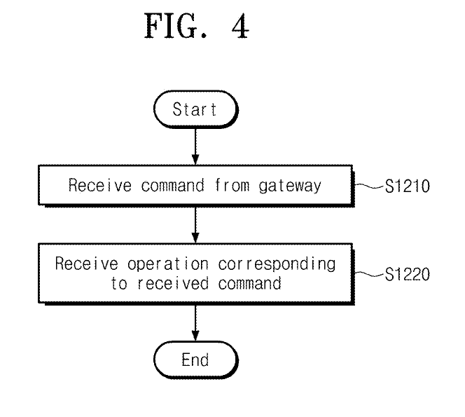

FIG. 4 is a flowchart of another operation of the healthcare device of FIG. 2. Referring to FIGS. 2 and 4, in step S1210, the healthcare device 1200 may receive a command from the gateway 1100. For example, the gateway 1100 may transmit a control command for collecting patient's biometric information from the healthcare device 1200. Alternatively, the gateway 1100 may transmit a security measure command so that the healthcare device 1200 performs a security measure.

In step S1220, in response to the received command, the healthcare device 1200 may perform an operation corresponding to the received command. For example, when the received command is a command for patient's biometric information collection, the device control unit 1240 may control the sensor unit 1210 to collect the patient's biometric information, and transmit the collected patient's biometric information to the gateway 1100. Alternatively, when the received command is the security measure command, the device control unit 1240 may perform a security operation in response to the received command.

As example embodiments, the healthcare device 1200 may operate under the control of the device management unit 1230, although not shown. For example, when the command received from the gateway 1100 is a command for collecting patient's biometric information but the program code of the healthcare device 1200 is not safe (i.e., when a verification result for the program code is failure), the device management unit 1230 may control the device control unit 1240 so that the device control unit 1240 does not operate in response to the received command. Alternatively, the device control unit 1240 may not perform a command received based on the verification result managed by the device management unit 1230.

As described above, the healthcare device 1200 may perform a self-verification operation according to a verification request from the gateway 1100. Thus, the reliability of the healthcare device 1200 with respect to internal error as well as external attack is enhanced.

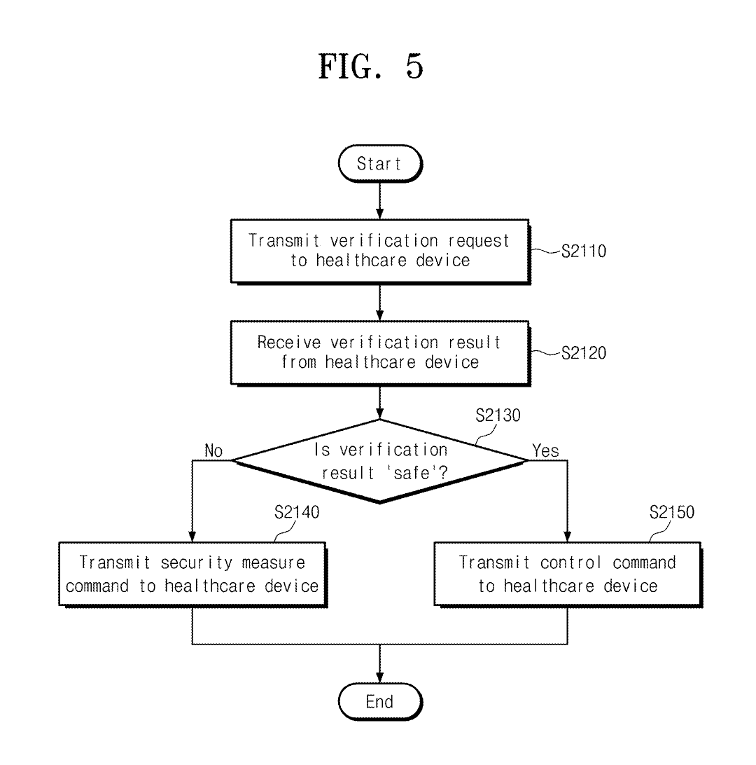

FIG. 5 is a flowchart of an operation of a gateway of FIG. 2.

Referring to FIGS. 2 and 5, in step S2110, the gateway 1100 may transmit a verification request to the healthcare device 1200. For example, the gateway 1100 may transmit the verification request to the healthcare device 1200 so that the healthcare device 1200 operates a verification operation.

In step S2120, the gateway 1100 receives a verification result from the healthcare device 1100. For example, the healthcare device 1100 may perform the verification operation in response to the verification request. The healthcare device 1200 may transmit a verification result to the gateway 1100.

In step S2130, the gateway 1100 may determine whether the received verification result is safe. For example, when the program code of the healthcare device 1100 is damaged, the verification result of the healthcare device 1100 would be fail. In contrast, when the program code of the healthcare device 1100 is safe, the verification result of the healthcare device 1100 would be safe.

When the verification result is safe, in step S2130, the gateway 1100 transmits a control command to the healthcare device 1200. The control command indicates a command for general operations of the healthcare device 1200 (i.e., an operation of collecting patient's biometric information, an operation of performing medical treatment, etc.).

When the verification result is fail, in step S2140, the gateway 1100 transmits a security measure command to the healthcare device 1200. The security measure command indicates a command for the security operation of the healthcare device 1200. As an example, the healthcare device 1200 that receives the security measure command may perform the security operation.

As an example, the gateway 1100 may provide information on the security operation (e.g., an update file) to the healthcare device 1200. The healthcare device 1200 may perform the security operation based on information provided from the gateway 1100.

According to an embodiment of the inventive concept as described above, the gateway 1100 transmits the control command or security measure command to the healthcare device 1200 according to the verification result of the healthcare device 120. Thus, a healthcare service system having enhanced reliability is provided.

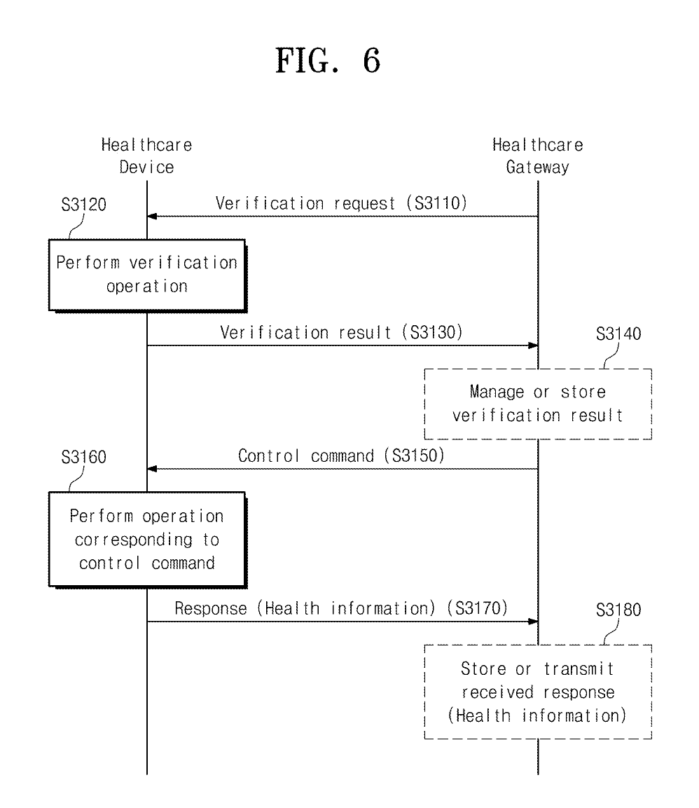

FIG. 6 is a diagram showing an operation of a healthcare service system of FIG. 2. As an example, the interaction of the gateway 1100 and the healthcare device 1200 is described with reference to FIG. 6. As an example, an embodiment where the healthcare device 1200 is safe (i.e., when the integrity of the components of the healthcare device 1200 is guaranteed) is described with reference to FIG. 6.

Referring to FIGS. 2 and 6, in step S3110, the gateway 1100 transmits a verification request to the healthcare device 1200. As an example, the gateway 1100 may transmit the verification request to the healthcare device 1200 regularly, irregularly, or in response to a request from the server 1001 (see FIG. 1).

In step S3120, the healthcare device 1200 performs a verification operation in response to the received verification request. As an example, the verification operation may indicate a verification operation for a program code performed at the healthcare device 1200, another software layer, or a hardware configuration. That is, the healthcare device 1200 may perform a self-verification operation to verify whether there the healthcare device is in a safe state.

In step S3130, the healthcare device 1200 may transmit a verification result to the gateway 1100. As an example, it is assumed that the verification result transmitted in step S3130 is safe.

In step S3140, the gateway 1100 may store and manage the received verification result. As an example, the operation in step S340 may be omitted.

In step S3150, the gateway 1100 may transmit a control command to the healthcare device 1200. For example, since the verification result received in step S3130 is safe, the gateway determines that the healthcare device 1200 is safe (i.e., the healthcare device 1200 normally operates). Thus, the gateway 1100 may transmit the control command to the healthcare device 1200. The control command indicates a command for the general operation of the healthcare device 1200.

In step S3160, the healthcare device 1200 may perform an operation corresponding to the received control command. For example, when the received control command is a patient's biometric information collect command, the healthcare device 1200 may collect patient's biometric information through the sensor unit 1210 to transmit the information to the gateway 1100. Alternatively, the healthcare device 1200 may transmit, to the gateway 1100, the patient's biometric information previously collected through the sensor unit 1210. Alternatively, when the received control command is a command for a medical treatment operation, the healthcare device 1200 may perform the medical treatment operation through the sensor unit 1210.

In step S3170, the healthcare device 1200 may transmit a response to the gateway 1100. As an example, the healthcare device 1200 may transmit the response including the patient's biometric information to the gateway 1100.

In step S3180, the gateway 1100 may store and transmit the response to the server 1001. As example embodiments, an operation of the step S3180 may be omitted.

As example embodiments, the operation methods of the gateway 1100 and the healthcare device 1200 as described above is exemplary, and the scope of the inventive concept is not limited thereto. For example, the gateway 1100 and the healthcare device 1200 perform verification operations and the request, command, information, etc. transmitted and received between the gateway 1100 and the healthcare device 1200 may vary according to the communication method between the gateway 1100 and the healthcare device 1200.

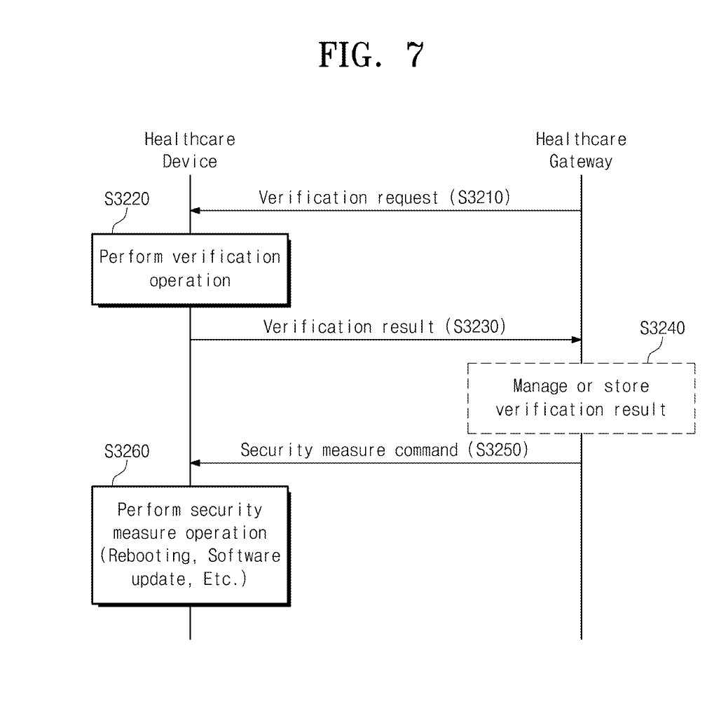

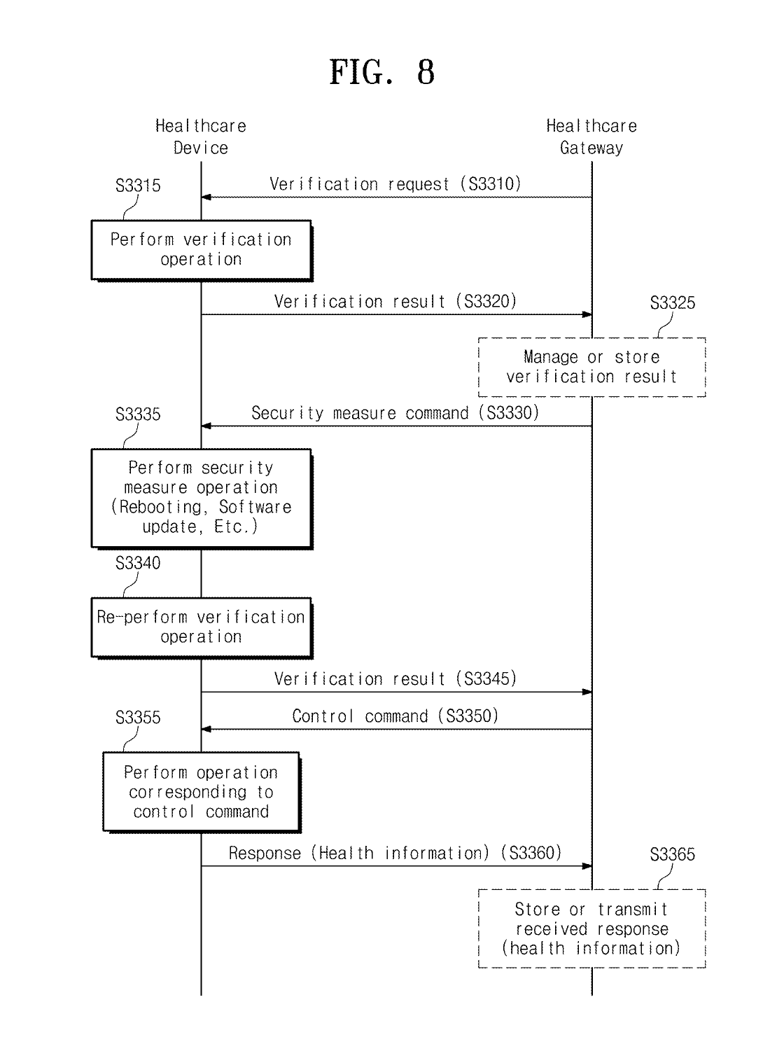

FIG. 7 and FIG. 8 are diagrams showing another operation of a healthcare service system of FIG. 2. As an example, an embodiment where the verification result of the healthcare device 1200 is fail is described with reference to FIGS. 7 and 8.

Referring to FIGS. 2 and 7, in step S3210, the gateway 1100 transmits a verification request to the healthcare device 1200. In step S3220, the healthcare device 1200 performs a verification operation in response to the received verification request. Since steps S3210 and S3220 are the same as steps S2210 and S2220 of FIG. 6, their detailed descriptions are omitted.

In step S3230, the healthcare device 1200 may transmit a verification result to the gateway 1100. As an example, the program code, another software layer or hardware component of the healthcare device 1200 may be damaged. In this case, the verification result of the healthcare device 1200 would be fail. The healthcare device 1200 may transmit the verification result of fail to the gateway 1100.

In step S3240, the gateway 1100 may store and manage the verification result. As an example, the operation in step S3240 may be omitted.

In step S3250, the gateway 1100 may transmit a security measure command to the healthcare device 1100. For example, since the verification result of the healthcare device 1200 is fail, the gateway 1100 may transmit a security measure command to the healthcare device 1200 so that the healthcare device 1200 performs a security measure.

In step S3260, the healthcare device 1200 may perform the security measure in response to the security measure command. For example, the healthcare device 1200 may perform a rebooting operation. Alternatively, the healthcare device 1200 may update software used in the healthcare device 1200. As an example, the gateway 1100 may provide information required for the security measure of the healthcare device 1200, and the healthcare device 1200 may perform the security measure based on information provided from the gateway 1100.

Next, referring to FIGS. 2 and 8, the gateway 1100 and the healthcare device 1200 may perform steps S3331 to S3335. Since steps S3310 and S3335 are the same as steps S3210 and S3260 of FIG. 7, their detailed descriptions are omitted.

In step S3340, the healthcare device 1200 may re-perform a verification operation. For example, in step S3335, the healthcare device 1200 may perform a security measure. That is, the healthcare device 1200 may recover an error due to an external attack or internal factor, through the security measure. Then, the healthcare device 1200 may re-perform the verification operation in order to inspect whether the security measure has been normally performed.

In step S3350, the healthcare device 1200 may transmit a re-verification result to the gateway 1100. As an example, since the healthcare device 1200 performs the security measure, the re-verification result would be safe.

Then, the gateway 1100 and the healthcare device 1200 may perform steps S3350 to S3365. Since steps S3350 and S3365 are the same as steps S3140 and S3180 of FIG. 6, their detailed descriptions are omitted.

As example embodiments, the type and order of the request, command, and information transmitted and received between the gateway 1100 and the healthcare device 1200 as described above with reference to FIGS. 7 and 8 are exemplary and the scope of the inventive concept is not limited thereto. For example, the gateway 1100 and the healthcare device 1200 performs the verification operation and the security measure and may communicate with each other based on the order and data type defined by the communication method between the gateway 1100 and the healthcare device 1200.

As described above, the healthcare device 1200 may perform a verification operation according to a verification request from the gateway 1100, and perform the security measure according to the security measure command. The healthcare device 1200 on which the security measure has been performed may perform a normal operation according to the control of the gateway 1100. Thus, since it is possible to prevent the malfunction of the healthcare device 1200 due to an external attack or internal error, a healthcare service system having enhanced reliability is provided.

According to the inventive concept, by preventing the malfunction of the healthcare device due to an external factor (e.g., hacking) or an internal factor (e.g., a program or hardware error), there is provided the healthcare device, the healthcare gateway, and the verification method of the healthcare device that have enhanced reliability.

Although the detailed description of the inventive concept has provided particular embodiments, there may be many variations without departing from the scope of the inventive concept. Therefore, the scope of the inventive concept should not be limited to the above-described embodiments but should be defined by equivalents of the following claims as well as the following claims.

What is claimed is:

1. A healthcare device comprising:
a sensor unit configured to collect patient's biometric information or perform medical treatment on the patient;
a communication unit configured to communicate with a healthcare gateway;
a control unit configured to receive a control command from the healthcare gateway through the communication unit and control the sensor unit according to the received control command; and
a device verification unit configured to receive a verification request from the healthcare gateway, verify an error of the control unit or the sensor unit in response to the received verification request, and transmit results of the verification to the healthcare gateway.

2. The healthcare device of claim 1, wherein the healthcare device is attached to a body of the patient.

3. The healthcare device of claim 1, wherein the control unit is configured to transmit the collected patient's biometric information to the healthcare gateway through the communication unit.

4. The healthcare device of claim 1, wherein the control unit is configured to receive a security measure command from the healthcare gateway when the verification result is fail.

5. The healthcare device of claim 4, wherein the control unit is configured to perform a security measure according to the received security measure command.

6. The healthcare device of claim 5, wherein the security measure comprises at least one of rebooting, program update, and hardware reset operations.

7. A healthcare gateway comprising:
a communication unit configured to communicate with a healthcare device;
a monitoring unit configured to receive a verification result from the healthcare device through the communication unit and manage the received verification result; and
a control unit configured to transmit any one of a control command or a security measure command to the healthcare device according to the verification result,
wherein the control command indicates a command corresponding to a normal operation of the healthcare device, and the security measure command indicates a command corresponding to a security measure of the healthcare device.

8. The healthcare gateway of claim 7, wherein the control unit is configured to transmit a security measure command to the healthcare device when the verification result is fail, and transmit a control command to the healthcare device when the verification result is safe.

9. The healthcare gateway of claim 8, wherein the control unit is configured to further transmit, to the healthcare device, information required for the security measure of the healthcare device when the verification result is fail.

10. The healthcare gateway of claim 7, further comprising a request management unit configured to receive the patient's biometric information from the healthcare device and manage the received patient's biometric information.

11. The healthcare device of claim 10, wherein the communication unit is configured to communicate with an external server and
wherein the request management unit is configured to transmit, to the external server, the managed patient's biometric information according to a request from the external server.

12. A verification method for a healthcare device comprising:
transmitting a verification request from a healthcare gateway;
performing a verification operation in response to the verification request to transmit the verification result to the healthcare gateway;
receiving any one of a control command and a security measure command from the healthcare gateway; and
performing any one of a normal operation and a security measure in response to any one of the control command and the security measure command,
wherein the normal operation indicates an operation of transmitting the collected patient's biometric information to the healthcare gateway or performing medical treatment on the patient by the healthcare device, and the security measure indicates an operation of performing rebooting or a software update by the healthcare device.

13. The verification method of claim 12, wherein the performing of the verification operation in response to the verification request to transmit the verification result to the healthcare gateway comprises performing verification on software used in the healthcare device based on a predefined key value.

14. The verification method of claim 12, wherein the performing of any one of the normal operation and the security measure in response to any one of the control command and the security measure command comprises receiving the security measure command from the healthcare gateway when the verification result is fail, and receiving the control command from the healthcare gateway when the verification result is safe.
